(19) United States
(12) Patent Application Publication
(10) Pub. No.: US 2024/0176031 A1
(43) Pub. Date: May 30, 2024

(54) RADIATION IMAGING APPARATUS, RADIATION IMAGING SYSTEM, AND CONTROL APPARATUS

(71) Applicant: CANON KABUSHIKI KAISHA, Tokyo (JP)

(72) Inventors: HIROKI ASAI, Kanagawa (JP); YUICHI NAITO, Kanagawa (JP); HIDEYUKI OKADA, Saitama (JP)

(21) Appl. No.: 18/516,765

(22) Filed: Nov. 21, 2023

(30) Foreign Application Priority Data
Nov. 29, 2022 (JP) 2022-190045

(51) Int. Cl. G01T 1/175; G01T 7/00

(52) U.S. Cl. CPC G01T 1/175; G01T 7/005

(57) ABSTRACT

A radiation imaging system includes a radiation imaging apparatus that can be in a start-up state where acquisition processing to acquire internal information is executed and in a standby state where the acquisition processing is not executed, and a control apparatus, wherein the control apparatus transmits a start-up signal to the radiation imaging apparatus, wherein the radiation imaging apparatus transitions from the standby state to the start-up state in response to receipt of the start-up signal, execute the acquisition processing, and transmit the internal information to the control apparatus, and wherein, in a case where the internal information received from the radiation imaging apparatus is internal information corresponding to a normal state of the radiation imaging apparatus, the control apparatus provides notification external to the radiation imaging system of information indicating that operation of the radiation imaging apparatus is normal.

### BACKGROUND

### Field

The present disclosure relates to a radiation imaging apparatus, a radiation imaging system, and a control apparatus.

### Description of the Related Art

In recent years a radiation imaging apparatus using a flat panel detector composed of solid-state imaging devices that are made of amorphous silicon or single crystal silicon and that are arrayed in a two dimensional shape has been widely put into practical use as an imaging apparatus used for a medical image diagnosis with radiation or a non-destructive inspection.

Such radiation imaging apparatuses accumulate signal charges generated in each pixel depending on a detection amount of radiation, read the electric charges, and perform analog-to-digital (AD) conversion on the electric charges to thereby acquire an image. For example, in the medical image diagnosis, such radiation imaging apparatuses are used as digital imaging apparatuses that perform still-image imaging as in general imaging and moving-image imaging as in fluorography.

Since a wireless radiation imaging apparatus has been developed that is easy to be handled, there are more opportunities to carry the wireless radiation imaging apparatus, such as in cases of installing the radiation imaging apparatus on an operating table or a mount or using the radiation imaging apparatus in an instrument carriage. Thus, there is a possibility that, for example, a failure due to dropping or the like can occur.

With the increased opportunities to carry around a wireless radiation imaging apparatus, there are a wide variety of surrounding environments in which the radiation imaging apparatus is installed. For example, with the presence of a medical device that generates magnetic noise, such as a magnetic resonance imaging (MRI) device, there are possibilities that, for example, an image is affected by noise and wireless communication is hindered.

To detect such abnormality, there is a case where test imaging is periodically performed to inspect whether a captured image is normal. For example, Japanese Patent Application Laid-Open No. 2002-277993 discloses a method of performing statistical processing on an analytic value obtained from image information acquired by an imaging apparatus, detecting abnormality of the imaging apparatus, and notifying a maintenance center of a detection result.

Since a wireless radiation imaging apparatus is operated by a battery, power saving is required. Thus, in a standby state where the radiation imaging apparatus waits for start-up or a standby state where the radiation imaging apparatus waits for an imaging protocol, the radiation imaging apparatus is under control not to operate an internal circuit as much as possible and operate the radiation imaging apparatus in a power saving state.

When abnormality occurs in the wireless radiation imaging apparatus in the power saving state, it is impossible to detect the abnormality in real time. Even if the abnormality is detected, in a case where the abnormality occurs in a means for notifying the maintenance center of a detection result, it is impossible for the maintenance center to detect the abnormality. As a result, the detection of the abnormality of the radiation imaging apparatus is delayed, and there is a possibility that usability in imaging is decreased.

### SUMMARY

The present disclosure is directed to a technique that enables detection of abnormality of a radiation imaging apparatus even during an operation in a power saving state and enables a notification external to a radiation imaging system the radiation imaging apparatus is part of.

According to an aspect of the present disclosure, a radiation imaging system includes a radiation imaging apparatus configured to be in a start-up state where acquisition processing to acquire internal information is executed and in a standby state where the acquisition processing is not executed, and a control apparatus, wherein the control apparatus is configured to transmit a start-up signal to the radiation imaging apparatus, wherein the radiation imaging apparatus is configured to transition from the standby state to the start-up state in response to receipt of the start-up signal, execute the acquisition processing, and transmit the internal information to the control apparatus, and wherein, in a case where the internal information received from the radiation imaging apparatus is internal information corresponding to a normal state of the radiation imaging apparatus, the control apparatus is configured to provide notification external to the radiation imaging system of information indicating that operation of the radiation imaging apparatus is normal.

Further features of the present disclosure will become apparent from the following description of exemplary embodiments with reference to the attached drawings.

### BRIEF DESCRIPTION OF THE DRAWINGS

FIG. 1 is a schematic view illustrating a radiation imaging system according to a first exemplary embodiment.

FIG. 2 is a functional block diagram of a radiation imaging apparatus according to the first exemplary embodiment.

FIG. 3 is a functional block diagram of a control apparatus according to the first exemplary embodiment.

FIG. 4 is a sequence chart when the radiation imaging system according to the first exemplary embodiment makes a normal notification.

FIG. 5 is a sequence chart when a radiation imaging system according to a second exemplary embodiment performs recalibration.

### DESCRIPTION OF THE EMBODIMENTS

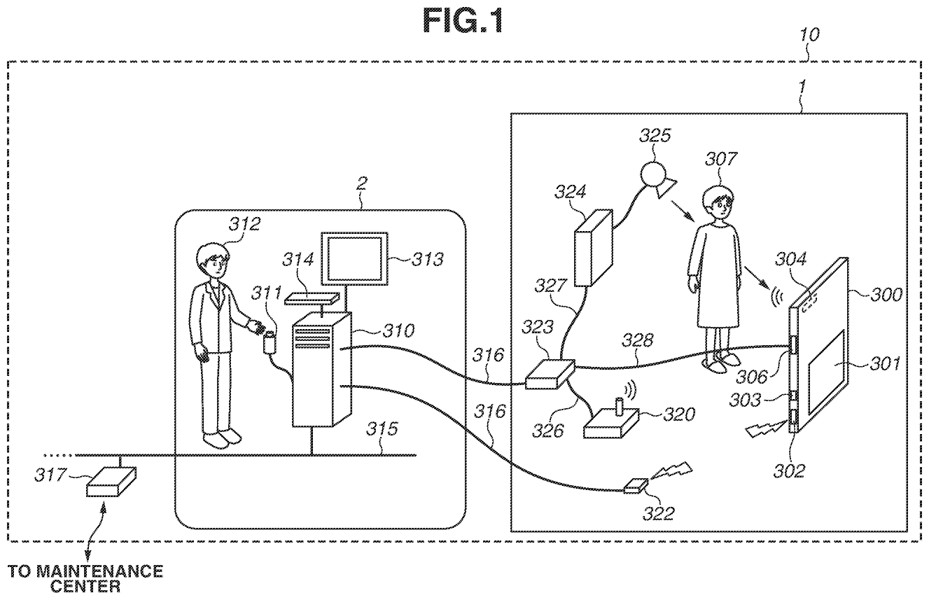

A radiation imaging system according to a first exemplary embodiment is described below with reference to the drawings. FIG. 1 is a diagram illustrating a radiation imaging system according to the first exemplary embodiment.

As illustrated in FIG. 1, a radiation imaging system 10 is installed in a radiation room 1 and a control room 2. In the radiation room 1, radiographing is performed by radiation irradiation. The control room 2 is located in the vicinity of the radiation room 1.

The radiation imaging system 10 includes, in the radiation room 1, a radiation imaging apparatus 300, an access point 320, a communication control apparatus 323, a radiation generating apparatus 324, and a radiation source 325.

The radiation imaging system 10 includes, in the radiation room 1, an entry apparatus 322, an access point (AP) communication cable 326, a radiation generating apparatus communication cable 327, and a sensor communication cable 328.

The radiation imaging system 10 includes, in the control room 2, a control apparatus 310, a radiation irradiation switch 311, a display apparatus 313, an input apparatus 314, an in-hospital local area network (LAN) 315, and a radiation room communication cable 316.

The radiation imaging apparatus 300 includes a power source control unit 301 including a battery (not illustrated), a short-range wireless communication unit 302, a registration switch 303, a wireless communication unit 304, and a wired communication unit 306. The radiation imaging apparatus 300 detects radiation that has penetrated a subject 307 and generates radiographic image data.

The access point 320 is an access point for wireless communication and is used by the radiation imaging apparatus 300 and the control apparatus 310 to perform communication via the communication control apparatus 323. Alternatively, communication between the radiation imaging apparatus 300 and the communication control apparatus 323 can also be implemented as wired communication using the sensor communication cable 328. In the present exemplary embodiment, as an example, the access point 320 performs communication using the wireless LAN in frequency bands of 2.4 gigahertz (GHz), 5 GHz, or 60 GHz.

The radiation generating apparatus 324 controls the radiation source 325 to irradiate the subject 307 with radiation.

The radiation generating apparatus 324 controls the radiation source 325 to perform irradiation based on a predetermined condition, and controls generation of radiation based on a signal indicating start or stop of irradiation by the radiation imaging apparatus 300.

The AP communication cable 326 is a cable for connecting the access point 320 and the communication control apparatus 323. The radiation generating apparatus communication cable 327 is a cable for connecting the radiation generating apparatus 324 and the communication control apparatus 323.

The control apparatus 310 communicates with the radiation generating apparatus 324 and the radiation imaging apparatus 300 via the communication control apparatus 323 and the access point 320 or the sensor communication cable 328, and performs overall control of the radiation imaging system 10.

The radiation irradiation switch 311 inputs a timing of radiation irradiation in response to an operation performed by an operator 312. The input apparatus 314 is an apparatus for inputting an instruction from the operator 312, and various kinds of input device, such as a keyboard and a touch panel, are used.

The display apparatus 313 is an apparatus that displays radiographic image data subjected to image processing and a graphic user interface (GUI), and a display or the like is used. The in-hospital LAN 315 is an in-hospital backbone network. The radiation room communication cable 316 is a cable for connecting the control apparatus 310 with the communication control apparatus 323 and the entry apparatus 322 in the radiation room 1.

Next, an operation of the radiation imaging system 10 is described.

First, the operator 312 performs an operation of registering the radiation imaging apparatus 300 to the radiation imaging system 10. When the registration switch 303 for registering the radiation imaging apparatus 300 is pressed by the operator 312, short-range wireless communication is started between the short-range wireless communication unit 302 of the radiation imaging apparatus 300 and the entry apparatus 322.

The control apparatus 310 transmits wireless connection-related information of the access point 320 to the radiation imaging apparatus 300 via short-range wireless communication with the entry apparatus 322. In a case of the wireless LAN, the wireless connection-related information includes, for example, a communication method such as Institute of Electrical and Electronics Engineers (IEEE) 802.11, a physical channel, a solid-state imaging device (SSID), or an encryption key.

The radiation imaging apparatus 300 makes settings of the wireless communication unit 304 based on the received wireless connection-related information. With the settings, the radiation imaging apparatus 300 establishes connection for wireless communication between the access point 320 and the wireless communication unit 304.

The wireless connection-related information can be transmitted to the radiation imaging apparatus 300 via the sensor communication cable 328 and the wired communication unit 306.

The operator 312 enters subject information, such as identification (ID), a name, and a birth date of the subject 307, and a part of the subject 307 to be imaged. After the part to be imaged is entered, the operator 312 fixes the posture of the subject 307 and the radiation imaging apparatus 300.

When preparation for imaging is completed, the operator 312 presses the radiation irradiation switch 311. When the radiation irradiation switch 311 is pressed, the subject 307 is irradiated with radiation from the radiation source 325.

The radiation imaging apparatus 300 performs wireless communication with the radiation generating apparatus 324, and performs control to start and end the radiation irradiation. Radiation with which the subject 307 is irradiated penetrates the subject 307 and is incident on the radiation imaging apparatus 300. The radiation imaging apparatus 300 converts incident radiation into visible light, and thereafter detects the visible light as a radiographic image signal using a photoelectric conversion device.

The radiation imaging apparatus 300 drives the photoelectric conversion device to read the radiographic image signal, causes an analog-to-digital (AD) conversion circuit to convert an analog signal to a digital signal, and thereby obtains digital radiographic image data. The obtained digital radiographic image data is transferred from the radiation imaging apparatus 300 to the control apparatus 310 via wireless communication.

The control apparatus 310 performs image processing on the received digital radiographic image data. The control apparatus 310 displays a radiographic image based on the digital radiographic image data subjected to the image processing on the display apparatus 313.

The control apparatus 310 also functions as an image processing apparatus and a display control apparatus.

A camera (not illustrated) is arranged in the radiation source 325, captures an image of the subject 307 and an image of the radiation imaging apparatus 300, and is used to support positioning of the subject 307 and the radiation imaging apparatus 300. The camera includes a wireless communication unit and performs wireless communication with the access point 320.

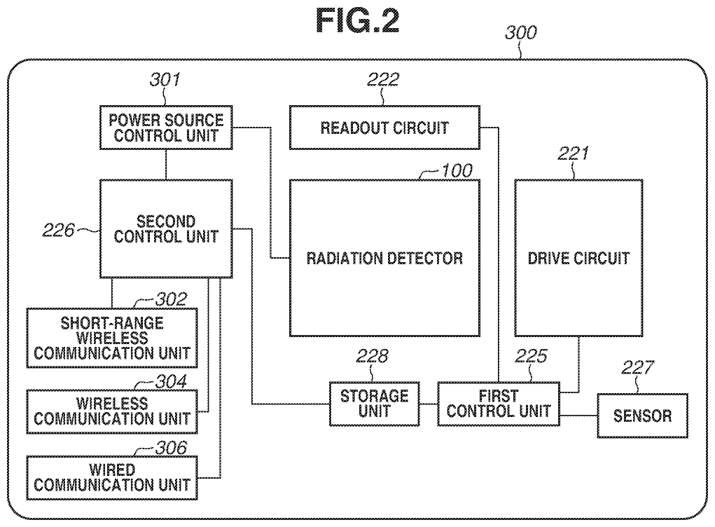

FIG. 2 is a functional block diagram of the radiation imaging apparatus 300. As illustrated in FIG. 2, the radiation imaging apparatus 300 includes a radiation detector 100. The radiation detector 100 has a function of detecting radiation with which the radiation detector 100 is irradiated. The radiation detector 100 includes a plurality of pixels (not illustrated) arrayed to constitute a plurality of rows and a plurality of columns. In the following description, an area of the radiation detector 100 where the plurality of pixels is arranged is referred to as an imaging area.

The radiation detector 100 includes a plurality of signal lines and a plurality of drive lines (not illustrated). Each signal line corresponds to one of the plurality of columns in the imaging area. Each drive line corresponds to one of the plurality of rows in the imaging area.

Each signal line is connected to a readout circuit 222 via connection lines (not illustrated). The readout circuit 222 includes a plurality of integral amplifiers, a plurality of multiplexers, and a plurality of analog-to-digital converters (hereinafter referred to as AD converters) (not illustrated). Each drive line is driven by a drive circuit 221 via connection lines (not illustrated).

The radiation detector 100 includes a bias line (not illustrated), and is connected to each pixel. A bias voltage Vs is supplied from the power source control unit 301 through the bias line.

The power source control unit 301 includes a battery, and a direct current-direct current (DC-DC) converter (not illustrated). The power source control unit 301 generates a power source for an analog circuit and a power source for a digital circuit that performs drive control, wireless communication, and the like.

A first control unit 225 controls the drive circuit 221, the readout circuit 222, or the like based on information from a signal processing unit (not illustrated) or a control command from the control apparatus 310. A second control unit 226 controls the short-range wireless communication unit 302, the wireless communication unit 304, the wired communication unit 306, and the like. In addition, the second control unit 226 performs control to start the first control unit 225, which will be described below.

A sensor 227 detects a state of the radiation imaging apparatus 300. The sensor 227 is connected to the first control unit 225, and includes one or more of an acceleration sensor, an angular velocity sensor, a temperature sensor, a current sensor, a voltage sensor, a magnetic sensor, a surface potential sensor, an optical sensor, or a water leakage sensor.

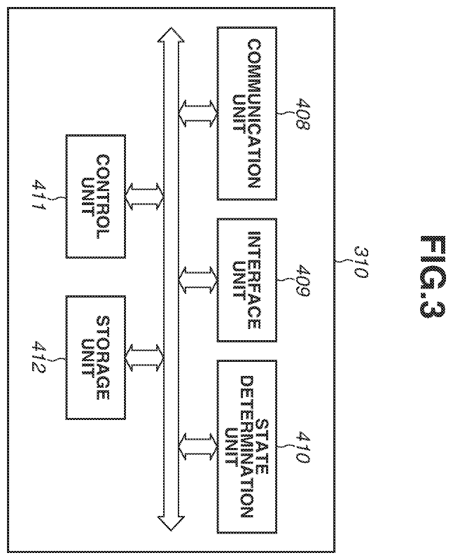

FIG. 3 is a functional block diagram of the control apparatus 310. As illustrated in FIG. 3, the control apparatus 310 includes a communication unit 408, an interface unit 409, a state determination unit 410, a control unit 411, and a storage unit 412.

The communication unit 408 performs communication via the radiation room communication cable 316. In addition, the communication unit 408 is also connected to the in-hospital LAN 315, which is the in-hospital backbone network. In a case where the state determination unit 410 determines that internal information of the radiation imaging apparatus 300 is within a normal range, the communication unit 408 transmits a notification about determination of normality to a maintenance center via a communication apparatus 317.

The interface unit 409 receives input from and performs output to the input apparatus 314 and the display apparatus 313. The state determination unit 410 determines whether the internal information of the radiation imaging apparatus 300 received from the radiation imaging apparatus 300 is within the normal range. The determination can be made by comparison with an upper limit value and a lower limit value of a normal value of each piece of information stored in the storage unit 412. The control unit 411 performs overall control of the control apparatus 310.

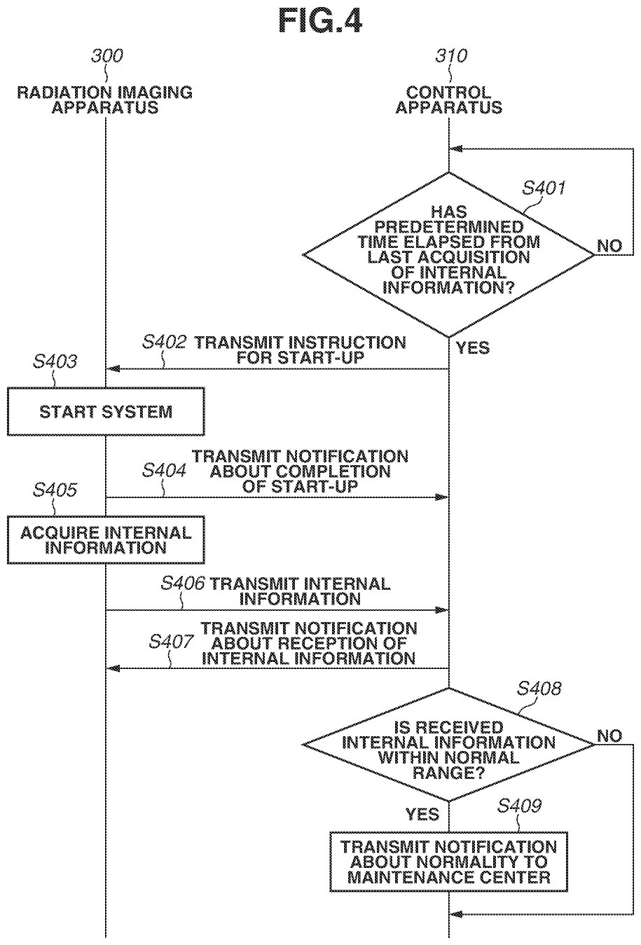

A description with reference to FIG. 4 will be provided of an operation in the radiation imaging system 10 having the above-described configuration where the internal information of the radiation imaging apparatus 300 is acquired, whether the information is within the normal range is determined, and the notification about determination of normality is transmitted to the maintenance center.

In a standby state where the radiation imaging apparatus 300 does not perform an imaging operation, the radiation detector 100, the drive circuit 221, the readout circuit 222, and the first control unit 225, which are used at the time of imaging, are in a power-off state. One or more of the second control unit 226, the short-range wireless communication unit 302, the wireless communication unit 304, or the wired communication unit 306 are in a power-on state, i.e., capable of communicating with the control apparatus 310.

In step S401, the control apparatus 310 reads acquisition time when the internal information is acquired and predetermined time corresponding to an acquisition interval from the storage unit 412, and determines whether the predetermined time has elapsed from acquisition of the internal information from the radiation imaging apparatus 300.

After the elapse of the predetermined time (YES in step S401), the processing proceeds to step S402. In step S402, the control apparatus 310 transmits a start-up signal including packets for start-up to the radiation imaging apparatus 300.

In step S403, the radiation imaging apparatus 300 receives the start-up signal from the control apparatus 310, and all components in the radiation imaging apparatus 300 enter an operable state. In the present exemplary embodiment, the radiation detector 100, the drive circuit 221, the readout circuit 222, and the first control unit 225, which have been in the power-off state, transition to the power-on state and are started under control of the second control unit 226.

Start-up of the radiation detector 100, the drive circuit 221, the readout circuit 222, and the first control unit 225 results in the radiation imaging apparatus 300 transitioning to a state of being able to perform imaging. Individual identification information on a radiation imaging apparatus that is desired to be started up can be added to the start-up signal. In a case where the radiation imaging apparatus 300 receives the start-up signal, the second control unit 226 compares the individual identification information in the start-up signal with individual identification information on the radiation imaging apparatus 300. In a case where this information does not match or in a case where this information matches but the first control unit 225 is already started, the second control unit 226 does not perform any specific processing.

In step S404, when the start-up of the radiation imaging apparatus 300 is completed, the radiation imaging apparatus 300 notifies the control apparatus 310 of completion of the start-up. The notification about the completion of the start-up can be transmitted by the wired communication unit 306, the wireless communication unit 304, or the short-range wireless communication unit 302 using any communication method. In the present exemplary embodiment, a method conforming with an IEEE 802.11 standard is used as a communication method of the wireless communication unit 304. Bluetooth® is used as a communication method of the short-range wireless communication unit 302. The communication method of the short-range wireless communication unit 302 and that of the wireless communication unit 304 are not limited thereto, and any known communication methods can be used.

When using Bluetooth® as the communication method, data can be added to an advertising signal transmitted. The wireless communication unit 304 and the short-range wireless communication unit 302 can be different functional areas in an identical electrical substrate.

In step S405, when the radiation imaging apparatus 300 is started, the radiation imaging apparatus 300 acquires the internal information of the radiation imaging apparatus 300. The internal information includes individual identification information stored in a storage unit 228, the number of images yet to be transferred, the number of images that can be stored, a remaining battery level, communication environment information, error information, an internal temperature, angle information, and position information.

The internal information can also include information, such as the variation, histogram, and in-plane distribution of average values of acquired images in a state where radiation irradiation is not performed, the bias voltage Vs in a predetermined period of time, data used in an auto exposure control (AEC) function, and an increase of defective pixels.

The error information includes, for example, information indicating that access to a device, such as the sensor 227 and the storage unit 228, has failed. Another example of the error information can be information indicating that the radiation imaging apparatus 300 has detected impact due to dropping or the like of the radiation imaging apparatus 300. The detection of impact can be implemented by a known sensor, such as an acceleration sensor, mounted on the sensor 227, and the sensor may detect addition of acceleration of a predetermined value or more to the radiation imaging apparatus 300.

In step S406, the radiation imaging apparatus 300 transmits the acquired internal information to the control apparatus 310. The transmission of the internal information, similar to the transmission of the notification about the completion of the start-up, can be performed by the wired communication unit 306, the wireless communication unit 304, or the short-range wireless communication unit 302 using any communication method.

In step S407, the control apparatus 310 notifies the radiation imaging apparatus 300 of reception of the internal information.

In step S408, the state determination unit 410 determines whether the received internal information is within the normal range compared to an upper limit value and a lower limit value of a normal value of each item of information stored in the storage unit 412.

For example, the acceleration sensor can detect that acceleration added to the radiation imaging apparatus 300 is a predetermined value or more, or the temperature sensor, the current sensor, or the voltage sensor can respectively detect that a temperature, a current, or a voltage of a predetermined value or more is generated in the radiation imaging apparatus 300.

The surface potential sensor can detect application of static electricity of a predetermined value or more to the radiation imaging apparatus 300. Leakage of light in the radiation imaging apparatus 300 can be detected from a value obtained by the optical sensor, such as an optical transistor, or leakage of water in the radiation imaging apparatus 300 can be detected from a value obtained by the water leakage sensor of a resistance detection method or the like.

Abnormalities can be detected from the variation, histogram, and in-plane distribution of average values of acquired images in the state where radiation irradiation is not performed, the information regarding the increase of defective pixels, the bias voltage Vs in the predetermined period of time, a value of data used in detection of a radiation irradiation dose with the AEC function, or the like.

When it is determined that all values of the internal information are within the normal range (YES in step S408), the processing proceeds to step S409. When it is determined that all values of the internal information are not within the normal range (NO in step S408), the processing skips step S409. In step S409, the control apparatus 310 transmits, external to the radiation imaging system 10, a notification that the radiation imaging apparatus 300 is normal via the in-hospital LAN 315 and the communication apparatus 317. An example of external to the radiation imaging system 10 is the maintenance center connected online to the radiation imaging system 10. As a result of the determination, if there is an item determined to be out of the normal range, the control apparatus 310 does not perform the transmission to the maintenance center.

In the maintenance center, it is assumed that a notification about normality is received from the radiation imaging system 10 in a predetermined cycle. In a case where the notification about normality is not received in the predetermined cycle, it is determined that abnormality has occurred in the radiation imaging system 10.

As described above, the radiation imaging system 10 according to the present exemplary embodiment periodically transmits the notification about normality, and can thereby detect, even in a case where abnormality has occurred in the radiation imaging apparatus 300 in the power saving state, abnormality of the radiation imaging apparatus 300 in real time.

In the first exemplary embodiment, the description has been provided of the radiation imaging system 10 that starts up the radiation imaging apparatus 300 in the power saving state in the predetermined cycle to acquire the internal information, and periodically transmits the notification about normality.

In a second exemplary embodiment, a description will be provided of a radiation imaging system that performs, in a case where it is determined that the internal information acquired in the predetermined cycle is out of the normal range, calibration on the radiation imaging apparatus 300, acquires the internal information again, and makes determination about normality.

The configuration of the radiation imaging system 10 in the present exemplary embodiment is identical to that of the first exemplary embodiment, and as such, description thereof is omitted.

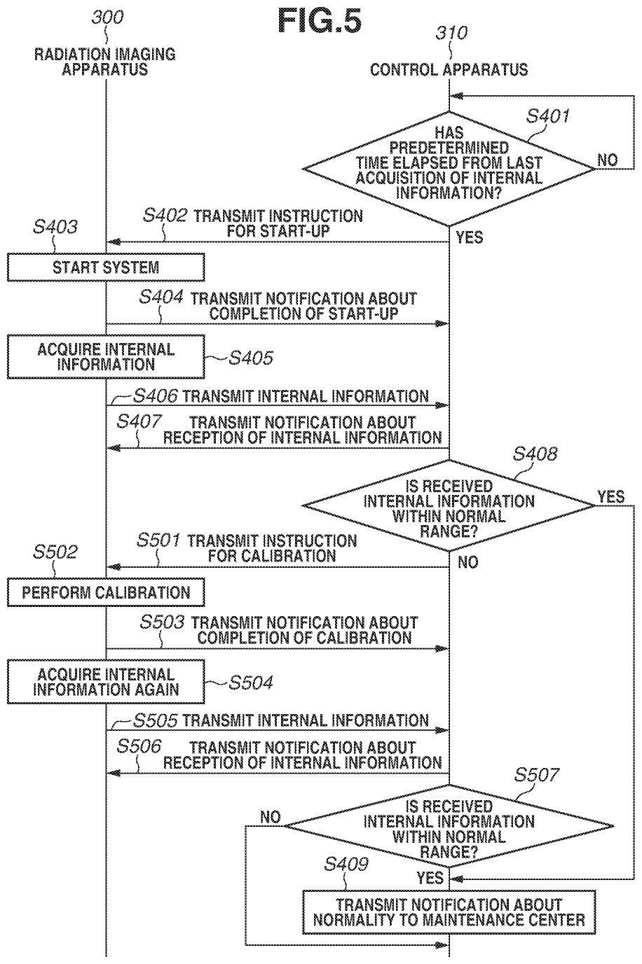

A description with reference to FIG. 5 will be provided of an operation in the radiation imaging system 10 where the internal information of the radiation imaging apparatus 300 is acquired, whether the information is within the normal range is determined, calibration is performed in a case where the internal information is out of the normal range, the internal information is acquired again, determination about normality is made, and the notification about determination of normality is transmitted to the maintenance center.

The processing from steps S401 to S408 is identical to the processing of the steps in FIG. 4, and a description thereof is omitted.

In a case where the internal information is out of the normal range (NO in step S408), the processing proceeds to step S501. In step S501, the control apparatus 310 transmits an instruction for calibration to the radiation imaging apparatus 300.

In step S502, when receiving the instruction for calibration from the control apparatus 310, the radiation imaging apparatus 300 performs various kinds of calibration. The calibration includes, for example, automatic extraction of a defective pixel, and addition of information corresponding to the defective pixel to defective pixel information. The radiation imaging apparatus 300 can acquire image data for correction processing having a possibility for a change over time, such as offset correction data and gain correction data, and update data in the storage unit 228. The radiation imaging apparatus 300 can also adjust a threshold that is used for detection of start of radiation irradiation or AEC depending on a variation in values of the bias voltage Vs or a variation in average values of acquired images in the state where radiation irradiation is not performed.

Clock adjustment can be performed in a case where clocks are different between apparatuses, such as between the radiation imaging apparatus 300 and the control apparatus 310. The radiation imaging apparatus 300 can switch an antenna to use from among a plurality of antennas based on a change of a communication state in wireless communication.

In step S503, when the calibration is completed, the radiation imaging apparatus 300 notifies the control apparatus 310 of completion of the calibration.

With respect to the processing in step S504 and subsequent steps, processing in step S504 is identical to the processing in step S405, processing in step S505 is identical to the processing in step S406, processing in step S506 is identical to the processing in step S407, processing in step S507 is identical to the processing in step S408, and processing in step S409 and determination in the maintenance center are identical to the processing and the determination in the first exemplary embodiment. Thus, descriptions thereof are omitted.

As described above, the radiation imaging system 10 according to the second exemplary embodiment performs recalibration on a parameter that changes with a change of a surrounding environment or a change over time, so that the radiation imaging apparatus 300 is in a usable state immediately after power-on.

While in the above-described embodiments, the control apparatus 310 includes the function of the state determination unit 410 that determines whether the acquired internal information is within the normal range, in other exemplary embodiments, the radiation imaging apparatus 300, the communication apparatus 317, or the maintenance center can include this function. When the radiation imaging apparatus 300 includes this function, a configuration where a signal indicating the notification about normality is transmitted from the radiation imaging apparatus 300 can be adopted.

In another exemplary embodiment, a configuration can be adopted where the determination whether the internal information is within the normal range is made in the radiation imaging apparatus 300, the radiation imaging apparatus 300 transmits both the internal information and the signal indicating the notification about normality in the radiation imaging apparatus 300 to the control apparatus 310, and the control apparatus 310 also transmits the signal indicating the notification about normality to the maintenance center only in a case where it is determined that the internal information is within the normal range in the control apparatus 310. This configuration also enables detection of abnormality of the state determination unit 410.

While in the above-described embodiments the control apparatus 310 includes the function of transmission of the start-up signal in the predetermined cycle, in other exemplary embodiments, the radiation imaging apparatus 300, the communication apparatus 317, or the maintenance center can include this function. When the radiation imaging apparatus 300 includes this function, a configuration where the second control unit 226 performs control to start up the first control unit 225 or the like in a predetermined cycle can be adopted.

While in the above-described embodiments the control apparatus 310 includes the function of transmission of the instruction for calibration, in other exemplary embodiments, the radiation imaging apparatus 300, the communication apparatus 317, or the maintenance center can include this function.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, these exemplary embodiments are not seen to be limiting. The scope of the following claims is to be accorded the broadest interpretation so as to encompass all such modifications and equivalent structures and functions.

This application claims the benefit of Japanese Patent Application No. 2022-190045, filed Nov. 29, 2022, which is hereby incorporated by reference herein in its entirety.

What is claimed is:

1. A radiation imaging system comprising:
a radiation imaging apparatus configured to be in a start-up state where acquisition processing to acquire internal information is executed and in a standby state where the acquisition processing is not executed; and
a control apparatus,
wherein the control apparatus is configured to transmit a start-up signal to the radiation imaging apparatus,
wherein the radiation imaging apparatus is configured to transition from the standby state to the start-up state in response to receipt of the start-up signal, execute the acquisition processing, and transmit the internal information to the control apparatus, and
wherein, in a case where the internal information received from the radiation imaging apparatus is internal information corresponding to a normal state of the radiation imaging apparatus, the control apparatus is configured to provide notification external to the radiation imaging system of information indicating that operation of the radiation imaging apparatus is normal.

2. The radiation imaging system according to claim 1, wherein the radiation imaging apparatus is configured to execute calibration processing followed by executing the acquisition processing.

3. The radiation imaging system according to claim 1,
wherein the radiation imaging apparatus includes a control unit, and
wherein, when the radiation imaging apparatus is in the standby state, the control unit is in a power-off state.

4. The radiation imaging system according to claim 1,
wherein the radiation imaging apparatus includes a control unit that is in a power-on state when the radiation imaging apparatus in the standby state, and
wherein the control unit is configured to be in the power-on state in response to receipt of the start-up signal.

5. The radiation imaging system according to claim 1, wherein the internal information includes information acquired from one or more of an acceleration sensor, an angular velocity sensor, a current sensor, a voltage sensor, a temperature sensor, a magnetic sensor, a surface potential sensor, an optical sensor, or a water leakage sensor.

6. The radiation imaging system according to claim 1,
wherein the radiation imaging apparatus includes a wireless communication unit configured to communicate with the control apparatus, and
wherein the wireless communication unit is configured to use one or more of an Institute of Electrical and Electronics Engineers (IEEE) 802.11 standard or Bluetooth®.

7. The radiation imaging system according to claim 1, wherein the control apparatus is configured to transmit the start-up signal to the radiation imaging apparatus in a predetermined cycle.

8. The radiation imaging system according to claim 1, wherein the control apparatus is configured to determine whether the internal information is out of normal range, and based on the determination, cause the radiation imaging apparatus to perform calibration of the radiation imaging apparatus.

9. A control apparatus used in a radiation imaging system including a radiation imaging apparatus configured to be in a start-up state where acquisition processing to acquire internal information is executed and in a standby state where the acquisition processing is not executed, the control apparatus comprising:
one or more controllers configured to:
transmit a start-up signal to the radiation imaging apparatus;
cause the radiation imaging apparatus to transition from the standby state to the start-up state;
cause the radiation imaging apparatus to execute the acquisition processing;
cause the radiation imaging apparatus to transmit the internal information to the control apparatus; and
provide, in a case where the internal information received from the radiation imaging apparatus is internal information corresponding to a normal state of the radiation imaging apparatus, notification external to the radiation imaging system of information indicating that operation of the radiation imaging apparatus is normal.

10. The control apparatus according to claim 9, wherein the internal information includes information acquired from one or more of an acceleration sensor, an angular velocity sensor, a current sensor, a voltage sensor, a temperature sensor, a magnetic sensor, a surface potential sensor, an optical sensor, and a water leakage sensor.

11. The control apparatus according to claim 9, wherein the control apparatus is configured to transmit the start-up signal to the radiation imaging apparatus in a predetermined cycle.

12. The control apparatus according to claim 9, wherein the control apparatus is configured to determine whether the internal information is out of normal range, and based on the determination, cause the radiation imaging apparatus to perform calibration of the radiation imaging apparatus.
